(19) United States
(12) Patent Application Publication
(10) Pub. No.: US 2010/0078339 A1
(43) Pub. Date: Apr. 1, 2010

(54) MULTIPLE CANDLESTICK ASSEMBLY

(76) Inventors: Jonathan Bar-Or, Pardes Hanna (IL); Hadar Shapira, Zichron Yaacov (IL); Ilan Vadai, Hod Hasharon (IL); Issac Shliser, Katzir (IL); Lihai Belski, Binyamina (IL); Oz Cohen, Modiin (IL)

Correspondence Address: Pearl Cohen Zedek Latzer, LLP, 1500 Broadway, 12th Floor, New York, NY, 10036, US

(21) Appl. No.: 12/523,913

(22) PCT Filed: Jan. 21, 2008
(86) PCT No.: PCT/IL08/00093

§ 371 Date: Jul. 21, 2009

Related U.S. Application Data
(60) Provisional application No. 60/897,054, filed on Jan. 24, 2007.

(51) Int. Cl. B65D 69/00; F23D 3/16; B29C 70/68

(52) U.S. Cl. 206/223; 431/295; 264/241

(57) ABSTRACT

A multiple candlestick assembly comprising at least two aligned candlestick bodies sharing a common base, where the candlestick bodies and the common base are integrally connected and co-molded. Also disclosed is a kit that includes a plurality of multiple candlestick assemblies of a varying number of aligned candlestick bodies.

### FIELD OF THE INVENTION

The present invention relates to candles. More specifically, the present invention relates to freestanding single & multiple candlestick assemblies and sets of combinations thereof.

### BACKGROUND OF THE INVENTION

Candles have been used for thousands of years and have played an important role in religious services & ceremonies in many faiths throughout history, as well as served for many other purposes.

There are several biblical references to candles. Emperor Constantine, for instance, used candles in the Easter service during the 4th century, Chanukah, the Jewish Festival of Lights dates back to 165 B.C. centers on the lighting of candles, and Christmas, the holiday that celebrates the birth of Jesus, is widely illuminated with candles.

Seeing that candles are used plentifully in religious services, holidays, birthday celebrations, and home decorations nowadays, inventors have kept designing candles of various types. Several patents disclosing methods for producing candles are described hereinafter.

U.S. Pat. No. 4,555,231 (Kustka) discloses a unity candle which includes two separate half sections with separate wicks on the adjoining surfaces of the two half sections. As the half sections are moved into registered engagement, the flames from the separate wicks merged into a single flame of increased size and intensity, which melts the wax of the candle to fuse the half sections together. The invention contemplates an improved method of symbolizing the joining of a couple in matrimony by placing the two half sections of the unity candle in spaced-apart relation, having the wicks of the half sections lit by respective individuals of the couple and then having the couple place the two half sections together with the adjoining surfaces in registered engagement to form a single unified candle.

EP 0,994,177 A2 (Bornstein et al) disclose vertically-disposed, vertically prismatically-sectioned candles with each section containing a separate wick and each section having a different function and/or different fragrance from at least one of its adjacent sections; processes for producing such vertically-disposed, vertically prismatically-sectioned, multi-fragranced and/or multifunctional candles; and kits for the creation of such multi-fragranced and/or multifunctional candles, comprising a multiplicity of alternative wick-containing sections having different functions and/or fragrances. Also described are processes for imparting a multiplicity of fragrances and/or a multiplicity of functional vapors to the environment surrounding the candles.

The different functions include fragrancing; insect repelling; aroma therapy; air freshening; and malodor coverage. The prismatic candle sections may be individually, differently colored and may be individually opaque or clear; with the clarity, opaqueness and particular color being indicative of a particular function and/or fragrance.

EP 0,018,839 A1 (Kent) discloses a multi-element candle structure made up of a plurality of superposed candle elements which frictionally engage one with another and which are not fused together. The candle elements may unite one with another to which end each candle element is formed with a projection at one end and a cavity at the other end so that the projecting end of one element can fit within the cavity in the abuting end of an adjacent element. Each candle element may have a central bore so that the aligned bores of the superposed elements form a continuous bore to receive a wick element.

CN 1,098,738 (Wang et al) discloses an artistic candle with multi-color flame, which comprises burning candle body and artistic stand. The candle body is composed of incendiary agent and composite candlewick including coloring strip and burning wick. More candlewicks may be arranged for single candle to generate more color. The candle features gay flame, stable burning, and no smoke and irritation smell.

SE 8,401,514 (Arne) discloses a candle comprised of a candle body of paraffin or stearine with a wick and surrounded by a casing comprised of a laminate or multi-layered material with an inner layer of a non-flammable and non-heat sensitive material such as a thin metal foil or a plastic material, a middle layer of a heat-tempered material such as a heat-tempered plastic and an outer layer of a structural material of an elective type such as cardboard, paper, plastic or other material with similar properties. The candle is produced through a candle body and wick that are manufactured separately and placed on a punched out container substance, after which the container substance is formed to a container, which tightly surrounds the candle body, either through the candle body being pressed down in a container mould for connection of the container substance or through the container substance being bent upward and surrounding the candle body. In the final stage of container formation heat is applied to the container or to the inner layer of the container at which the heat-tempered middle layer solidifies the container into its final form.

Other inventions related to candles are disclosed in

U.S. Pat. No. 3,744,956,

### EP 0,719,855,

### WO 99/51912,

### CN 2,564,848Y,

### CN 2467521Y,

### CN 2226069Y,

### TW 454853 Y.

Thus, candles exist in various sizes, shapes, colors, scents, and textures nowadays. Furthermore, numerous unique and artistic designs as described above are also widely available.

An aim of the present invention is to introduce a candle design unique and distinguished to existing candles. The present design includes single & multiple freestanding candlestick bodies interconnected by a single common base.

Another aim of the present invention is to provide a set of combinations of multiple candlestick bodies on a shared base.

The advantages and objects of the inventive design will become apparent after reading the present specification and reviewing the accompanying figures.

### SUMMARY OF THE INVENTION

There is thus provided, in accordance with some preferred embodiments of the present invention, a multiple candlestick assembly comprising:

at least two aligned candlestick bodies sharing a common base, wherein the candlestick bodies and the common base are integrally connected and co-molded.

Furthermore, in accordance with some preferred embodiments of the present invention, the common base comprises a flat bottom surface

Furthermore, in accordance with some preferred embodiments of the present invention, each of the candlestick bodies comprises at least one wick.

Furthermore, in accordance with some preferred embodiments of the present invention, said at least one wick comprises flame retarding substance so as to stop burning of the wick at a predetermined position.

Furthermore, in accordance with some preferred embodiments of the present invention, the candlestick bodies are substantially equal in size.

Furthermore, in accordance with some preferred embodiments of the present invention, the candlestick bodies are substantially equal in shape.

Furthermore, in accordance with some preferred embodiments of the present invention, the common base has a side panel that is shaped in a predetermined shape so as to match a corresponding side panel of another such assembly or of a single candlestick body such as a “Shamash” intended to be used for lighting the Chanukiah/Menora during the Jewish holiday of Chanukah.

Furthermore, in accordance with some preferred embodiments of the present invention, there is provided a kit of multiple-candlestick assemblies comprising:

a plurality of multiple candlestick assemblies of a varying number of aligned candlestick bodies sharing a common base, wherein the candlestick bodies and the common base are integrally connected and co-molded.

Furthermore, in accordance with some preferred embodiments of the present invention, the varying number is between 1 to 8.

Furthermore, in accordance with some preferred embodiments of the present invention, the kit is further provided with a box in which the multiple candlestick assemblies are stored.

Furthermore, in accordance with some preferred embodiments of the present invention, the box is provided with partitions defining compartments into which the multiple candlestick assemblies are placed.

Furthermore, in accordance with some preferred embodiments of the present invention, the kit is further provided with a tray.

### BRIEF DESCRIPTION OF THE DRAWINGS

In order to better understand the present invention, and appreciate its practical applications, the following figures are provided and referenced hereafter. It should be noted that the figures are given as examples only and in no way limit the scope of the invention. Like components are denoted by like reference numerals.

FIG. 1 is an isomeric view of a multiple candlestick assembly comprising co-molded eight candlestick bodies.

FIG. 2 is an isomeric view of multiple candlestick assembly of co-molded five candlestick bodies placed aligned with a single candlestick body, serving as a “Shamash”.

FIG. 3a illustrates a front view of a multiple candlestick assembly comprising two co-molded candlestick bodies adjacent to a single candlestick body.

FIG. 3b illustrates a bottom view of a multiple candlestick assembly comprising two co-molded candlestick bodies adjacent to a single candlestick body.

FIG. 3c illustrates a side view of a multiple candlestick assembly comprising two co-molded candlestick bodies adjacent to a single candlestick body.

FIG. 4 illustrates a front view of a candlestick body including a wick preprocessed at a predetermined position with a flame retardant substance.

FIG. 5 illustrates an isomeric view of a full Chanukiah (comprising eight co-molded candlestick bodies and a separate “Shamash” candlestick).

FIG. 6 illustrates a kit arrangement of combination sets of multiple candlestick assemblies for use during the entire holiday of Chanukah.

### DETAILED DESCRIPTION OF PREFERRED EMBODIMENTS

In accordance with a preferred embodiment of the present invention, a series of candlestick bodies interconnected by a joint segment is co-molded. The joint segment is preferably but not necessarily designed to be away from the wicks and serves as the supporting base of the candlestick bodies in accordance with the present invention, facilitating safely by placing the multiple candle assembly on a flat surface. Consequently, candleholders, containers, or other surfaces for securing the candlestick bodies into place are rendered unnecessary.

In addition, the wicks used in some embodiments of the present invention are preprocessed with flame retardants such as RG53 FR Biresin™ manufactured by SiKA (Germany) and fire retention paint such as Copon LS2000 manufactured by Tambur (Israel) so that the burning process terminates at predetermined locations somewhere in the vicinity of the base, leaving the base intact.

A multiple candlestick assembly according to a preferred embodiment of the present invention comprises sets of combinations of multiple candlesticks assemblies sharing the same base. More specifically, sets of multiple candlestick assemblies may be provided in numbers from a series, for example, 1, 2, 3, 4, 5, 6, 7, 8 (or other series).

Furthermore, the design, in accordance with a preferred embodiment of the present invention, is such that it allows connecting one candlestick assembly to another (or to a single candlestick body). This is particularly useful when considering the Jewish holiday of Chanukah in which each night, during a period of 8 days, candles are lit in a sequence ranging from 1 to 8 candles (each day an additional candle is lit). Chanukah candles are lit with the aid of an additional candle called the “Shamash”, which according to Jewish rules must be separated from the rest of the candles. After lighting up a series of candlesticks, the “Shamash” is placed alongside the other candles and complements the Chanukah Menora.

In accordance with a preferred embodiment of the present invention, a plurality of multiple-candlestick assemblies of a varying number of aligned candlestick bodies is packed in a kit.

Such packaging arrangement again suits the Jewish holiday, Chanukah, which requires the sequential lighting of candles or lights over a period of eight days with the number of candles (or lights) corresponding to the day of the holiday (i.e., one candle on the first day, two candles on the second day, three candles on the third day and so on).

Thus, in accordance with the present invention, a daily set is simply retrieved at once, and there is no need to count and arrange the candles on a holder, as the set is self-supported.

Reference is now made to the figures.

Some figures include contour lines for emphasizing the shape and volume of the candlestick bodies.

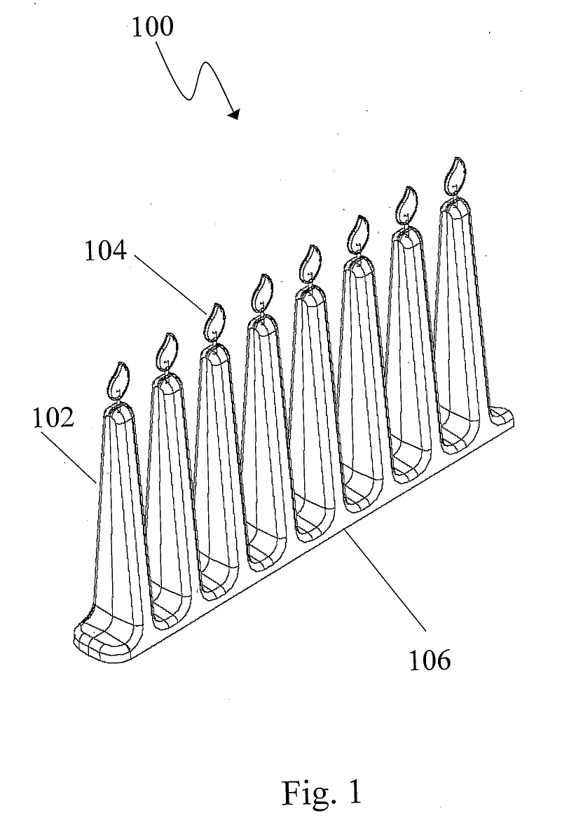

FIG. 1 is an isomeric view of a multiple candlestick assembly 100. As seen, multiple candlestick assembly 100 comprises co-molded eight separate candlestick bodies 102 each having wick 104. Base segment 106 interconnects candlestick bodies 102 and serves as a common base to candlestick bodies 102. It has a flat bottom surface, so as to allow safely placing the multiple candlestick assembly on a flat surface ensuring it is well balanced.

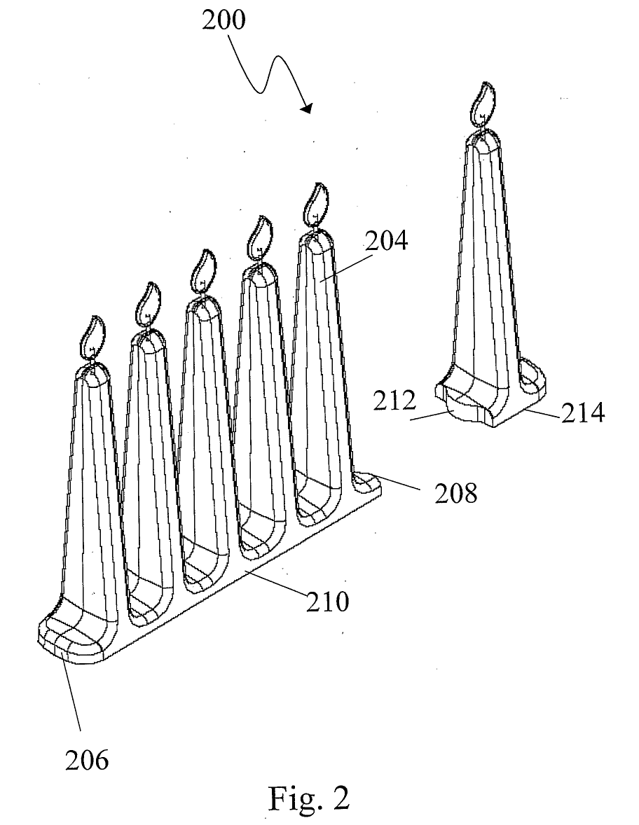

FIG. 2 is an isomeric view of multiple candlestick assembly 200 of co-molded five candlestick bodies placed aligned with a single candlestick body, serving as a “Shamash”. As seen in the figure, side 208 of base 210 and side 212 of base 214 are designed to match so as to present continuity, when placed adjacently. The opposite side 206 of base 210 (and the opposite side of base 214) can be shaped in any desired shape—here it is smoothly curved.

It should be noted that side 208 of base 210 and side 212 of base 214 can be designed in various shapes as long as they match and present continuity, when placed adjacently.

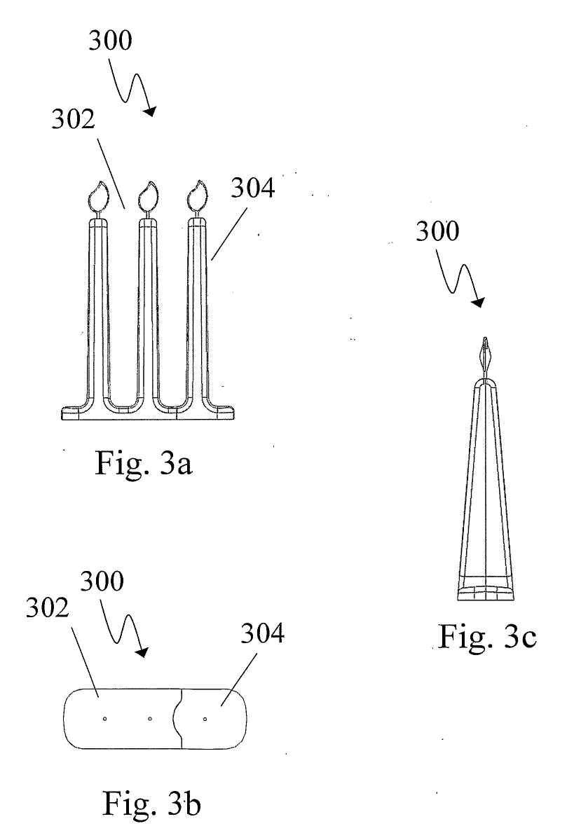

FIG. 3a illustrates a front view of array 300 comprising two joined multiple candlestick assemblies, 302, 304.

FIG. 3b illustrates a bottom-view of an array 300 comprising two joined multiple candlestick assemblies, 302, 304.

FIG. 3c illustrates a side view of candlestick array 300 comprising two joined multiple candlestick assemblies, 302, 304.

The figures illustrate candlestick array 300 comprising three candlestick bodies two 302 of which are co-molded and adjacently placed near single candlestick body 304.

The candlestick bodies, in accordance with a preferred embodiment of the present invention, are all equal in shape, which is kind of pointy at the tip and gradually broadens towards the base.

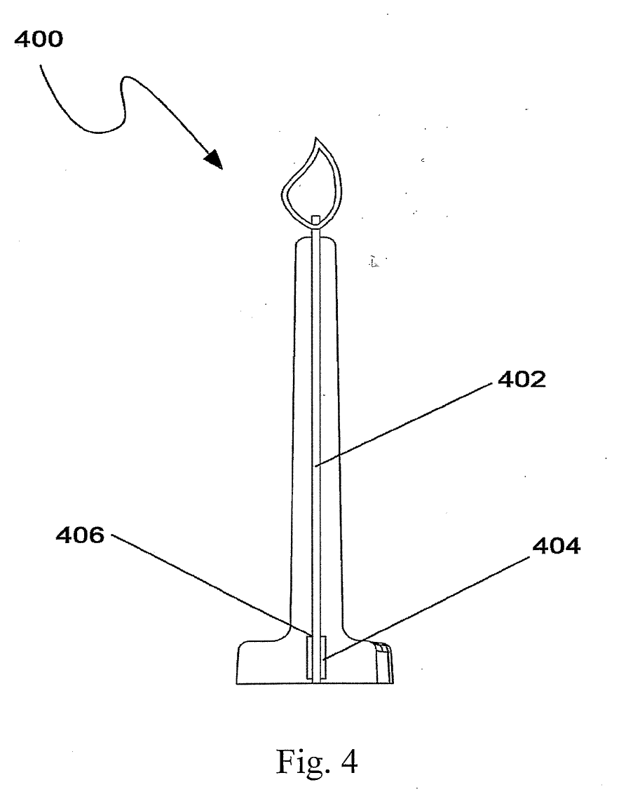

FIG. 4 illustrates a front view of candlestick body 400. The figure shows wick 402 preprocessed with a flame retardant substance at predetermined position 404 for terminating the burning process at predetermined location 406.

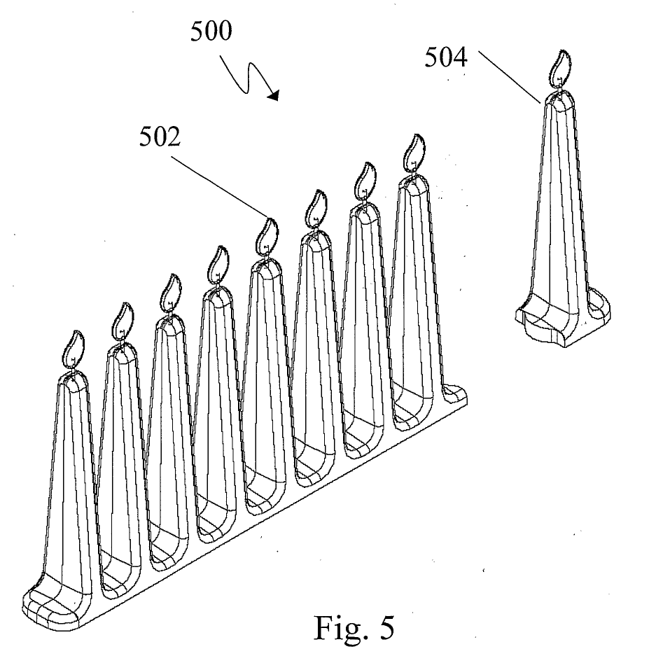

FIG. 5 illustrates an isomeric view of a full Chanukiah 500 (Chanukah Menora, set for the last eighth day of Chanukah), which includes a set of 8 candlestick bodies 502 and Shamash 504. The set shown in the figure suits the eighth day of the holiday as it consists of eight candles. Similar sets of fewer candles such as 7, 6, 5 and so on are provided, that are suited for the earlier days of the holiday (i.e., the seventh, sixth, fifth day etc. . . . )

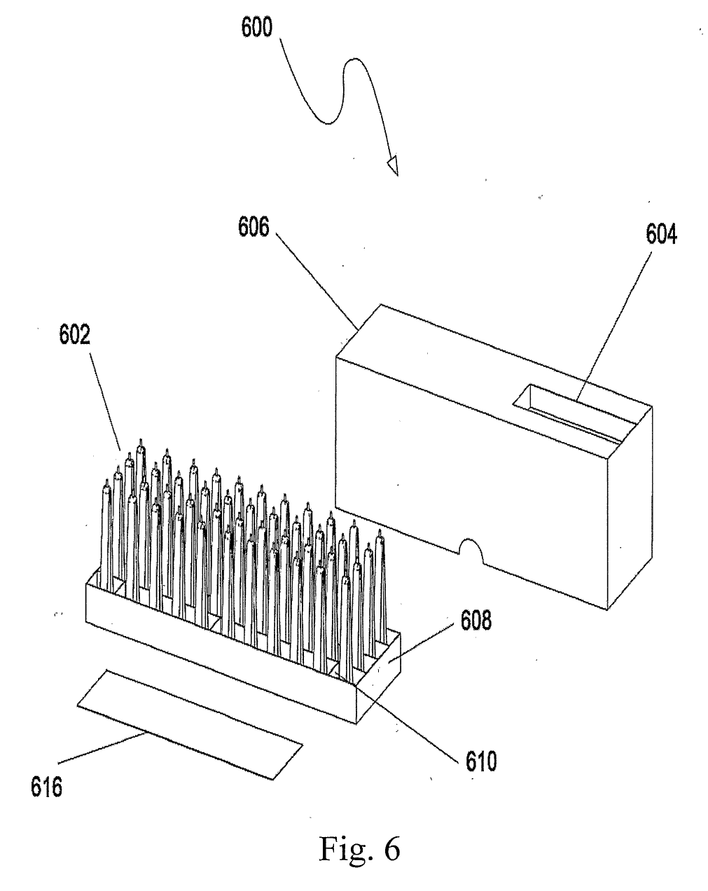

FIG. 6 illustrates kit 600 of multiple candlestick assembly sets 602 for use during the entire holiday of Chanukah. As seen in the figure, kit 600 consists a box designed in Such a way that portion 604 of top cover 606 is either made from a transparent material or is simply missing so that the content of the box can be viewed from the outside. Also, bottom part 608 of the box is partitioned into compartments 610 where each compartment 610 houses a multiple candlestick assembly of a predetermined number of candlestick bodies suitable for a specific day of Chanukah and one “Shamash” intended to be used for lighting the Chanukiah/Menora on that day. Having such packaging arrangement, the daily candlestick assembly is easily identified and retrieved from the box.

In addition, kit 600 includes tray 616 on top of which a multiple candlestick assembly is placed while in use.

In accordance with a preferred embodiment of the present invention, the multiple candlestick assembly described herein is of candlestick bodies equal in shape and size. It should be mentioned, however, that the multiple candlestick assembly may include candles differing in sizes, shapes, colors, scents, textures and the like.

Also, in accordance with a preferred embodiment of the present invention, the candlestick assemblies are produced by molding (i.e., the common way for candle production nowadays). However, production techniques other than molding can also be applied for producing the candlestick assemblies described herein.

The production process, in accordance with a preferred embodiment of the present invention, comprises the step of pouring wax into a mold containing wicks or pouring wax into a mold designed in such a way to produce an assembly of candlesticks with bores throughout the candlestick bodies. In general, the bores have the form of a cylindrical tube. Then, when the wax hardens, a rigid pre-wick assembly of a wick coated with paraffin is inserted into each candlestick body.

It should be clear that the description of the embodiments and attached figures set forth in this specification serves only for a better understanding of the invention, without limiting its scope.

It should also be clear that a person skilled in the art, after reading the present specification could make adjustments or amendments to the attached figures and above described embodiments that would still be covered by the present invention.

1. A multiple candlestick assembly comprising:
at least two aligned candlestick bodies sharing a common base, wherein the candlestick bodies and the common base are integrally connected and co-molded.

2. The assembly as claimed in claim 1, wherein the common base comprises a flat bottom surface

3. The assembly as claimed in claim 1, wherein each of the candlestick bodies comprises at least one wick.

4. The assembly as claimed in claim 3, wherein said at least one wick comprises flame retarding substance so as to stop burning of the wick at a predetermined position.

5. The assembly as claimed in claim 1, wherein the candlestick bodies are substantially equal in size.

6. The assembly as claimed in claim 1, wherein the candlestick bodies are substantially equal in shape.

7. The assembly as claimed in claim 1, wherein the common base has a side panel that is shaped in a predetermined shape so as to match a corresponding side panel of another such assembly.

8. The assembly as claimed in claim 1, wherein the common base has a side panel that is shaped in a predetermined shape so as to match a corresponding side panel of a single candlestick body.

9. A kit of multiple-candlestick assemblies comprising:
a plurality of multiple candlestick assemblies of a varying number of aligned candlestick bodies sharing a common base, wherein the candlestick bodies and the common base are integrally connected and co-molded.

10. The kit of claim 9, wherein the varying number is between 1 to 8.

11. The kit as claimed in claim 9, further provided with a box in which the multiple candlestick assemblies are stored.

12. The kit of claim 11, wherein the box is provided with partitions defining compartments into which the multiple candlestick assemblies are placed.

13. The kit as claimed in claim 11, further provided with a tray.

14. A method for producing a multiple candlestick assembly comprising:
pouring wax into a pre-designed mold, wherein said mold includes wicks.

15. A method for producing a multiple candlestick assembly comprising:
pouring wax into a pre-designed mold for producing candlestick bodies with bores, wherein said bores run throughout each candlestick body.

16. The method of claim 15, comprises a step of inserting a rigid pre-wick assembly of a wick coated with paraffin into each candlestick of said candlestick assembly.
